(19) United States
(12) Patent Application Publication
(10) Pub. No.: US 2002/0046051 A1
(43) Pub. Date: Apr. 18, 2002

(54) Electronic concession stand

(76) Inventors: Elliot Katzman, N. Andover, MA (US); David Block, Sudbury, MA (US); David Eicher, Walpole, MA (US)

Correspondence Address: Patent Group, Hutchins, Wheeler & Dittmar, 101 Federal Street, Boston, MA, 02110, US

(21) Appl. No.: 09/925,936

(22) Filed: Aug. 9, 2001

Related U.S. Application Data
(63) Continuation-in-part of application No. 09/546,000, filed on Apr. 10, 2000.
(63) Continuation-in-part of application No. 09/545,739, filed on Apr. 10, 2000.
(63) Continuation-in-part of application No. 09/563,723, filed on May 2, 2000.
(60) Provisional application No. 60/223,898, filed on Aug. 9, 2000.
(60) Provisional application No. 60/172,983, filed on Dec. 10, 1999.
(60) Provisional application No. 60/172,983, filed on Dec. 10, 1999.
(60) Provisional application No. 60/172,983, filed on Dec. 10, 1999.
(60) Provisional application No. 60/196,510, filed on Apr. 10, 2000.

(51) Int. Cl. G06F 7/00

(52) U.S. Cl. 705/1; 707/104.1; 707/1

(57) ABSTRACT

Described are techniques used in an on-line concession stand using software. The on-line concession stand (MCS) application includes an order wizard, a supplier console and a database of information. The MCS application provides for users to view and purchase products on-line from suppliers. Any one or more a variety of communication techniques and devices may be used in completing the transaction including instant messaging. A database organization includes a data organization to facilitate the transaction as well as electronic browsing.

### CROSS-REFERENCES TO RELATED APPLICATION(S)

This application claims priority to U.S. provisional patent application No. 60/223,898 filed on Aug. 9, 2000, and is a continuation-in-part of pending U.S. application Ser. No. 09/546,000, filed Apr. 10, 2000, which is herein incorporated by reference and which claims priority to U.S. provisional application No. 60/172,983, filed on Dec. 10, 1999; and is a continuation-in-part of U.S. application Ser. No. 09/545,739, filed Apr. 10, 2000, which is herein incorporated by reference and which claims priority to U.S. provisional application No. 60/172,983, filed on Dec. 10, 1999; and is a continuation-in-part of pending U.S. application Ser. No. 09/563,723 filed May 2, 2000 and which claims priority to U.S. provisional application No. 60/172,983, filed on Dec. 10, 1999 and U.S. provisional application No. 60/196,510 filed on Apr. 10, 2000.

### BACKGROUND

1. Technical Field

This application generally relates to computer systems, and more particularly to use of a computer system in electronic transactions.

2. Description of Related Art

Computer systems may be used for performing any one or more of a variety of different operations. With the use of the Internet, computer systems may be used for on-line shopping and other business activities. In particular, users may purchase supplies and “electronically browse” the available items for sale by one or more vendors having electronic websites. Businesses and individuals alike may use this capability. Electronic browsing may be performed using any one or more devices, such as a computer system, or other micro-browser device, and connections capable of connecting, for example, to the Internet.

Thus, it may be desirous and advantageous to have an efficient technique and system for facilitating “electronic browsing” and purchasing. It may also be desirous to organize information in an arrangement that facilitates efficient retrieval and use in accordance with particular functionality and operations.

### SUMMARY OF THE INVENTION

In accordance with one aspect of the invention is a method executed in a computer system for communicating with at least one member. Member profile information associated with said at least one member is determined, The member profile information includes one of schedule information and member activity information. Vendor profile information associated with a vendor is determined. The vendor determines a predetermined condition and associated action to be taken in response to an occurrence of said predetermined condition. At least one member is selected in accordance with at least one of: said predetermined condition and an occurrence of said predetermined condition. A preferred mode of communication of said at least one member is automatically determined. A communication is automatically sent in accordance with said associated action to said at least one member using said preferred mode of communication. The communication is customized in accordance with one of said scheduling information and said member activity information.

In accordance with another aspect of the invention is a computer program product for communicating with at least one member comprising machine executable code for: determining member profile information associated with said at least one member, said member profile information including one of schedule information and member activity information; determining vendor profile information associated with a vendor; determining, by said vendor, a predetermined condition and associated action to be taken in response to an occurrence of said predetermined condition; selecting said at least one member in accordance with at least one of: said predetermined condition and an occurrence of said predetermined condition; automatically determining a preferred mode of communication of said at least one member; and automatically sending a communication in accordance with said associated action to said at least one member using said preferred mode of communication, said communication being customized in accordance with one of said scheduling information and said member activity information.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment of a computer system according to the present invention;

FIG. 2 is an example of an embodiment of software that may execute in the server system of the computer system of FIG. 1;

FIG. 3 is an example of an embodiment of software that may execute in a client system of the computer system of FIG. 1; and

FIG. 4 is a list of tables that may be included in an embodiment of the database included in the system of FIG. 1; and

FIGS. 5-14 are more detailed examples of the tables included in FIG. 4 that may be included an embodiment.

### DETAILED DESCRIPTION OF EMBODIMENT(S)

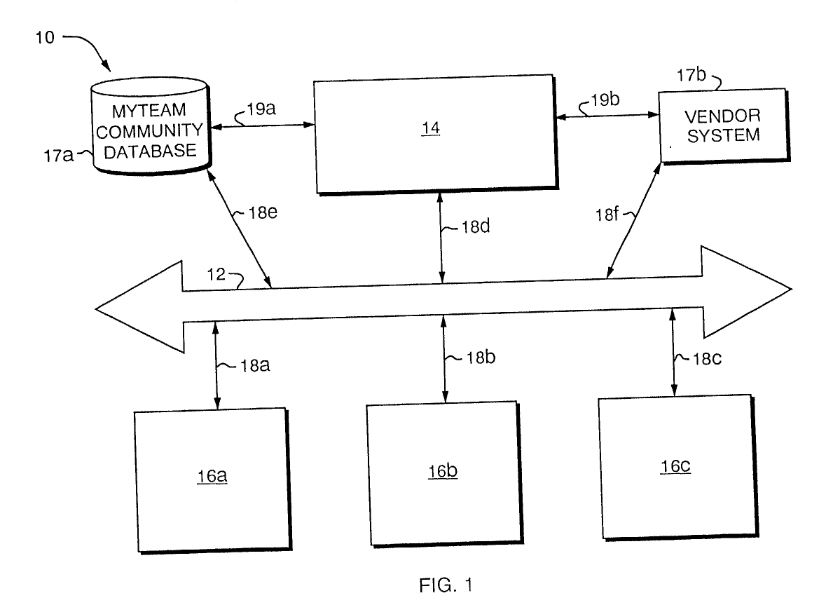

Referring now to FIG. 1, shown is an example of an embodiment of a computer system. The computer system 10 includes a server system 14 connected to a network 12 by network connection 18d. Also included in this embodiment of a computer system 10 are N client systems 16a, 16b, and 16c connected to the network 12, respectively, by network connection 18a, 18b and 18c. Also shown in FIG. 1 is a myteam community database 17a and a vendor system 17b. Each of 17a and 17b are connected to the network 12, respectively, by connections 18e and 18f. Additionally, each of 17a and 17 are also connected to the server system 14.

Other embodiments of the computer system 10 may include a different number of both client and server systems. Additionally, it should be noted that in this particular embodiment as described herein, the network 12 may be the Internet, or other type of network or non-network connection or communication medium, using any one or more of a variety of communications protocols. Other embodiments may include other kinds of networks, such as an intranet, or any one of a variety of other network or communication connections known to those skilled in the art. The client and server systems 16a, 16b, 16c, and 14 may be any one of the variety of computer processors. For example, in one embodiment, each of the client systems 16a, 16b and 16c may be personal computers connected to the Internet 12 through a dial up modem using services provided by an Internet service provider (ISP). The Internet connections represented by 18a-18f may be any one of a variety of network connections as may be provided and supported in accordance with the type of network 12. The processors 16a, 16b and 16c may be, for example, any one of the variety of commercially available personal computers, such as an Intel-based processor, Motorola-based processor or other commercially available devices, or a hand held device, such as microbrowser device that may use the Wireless Access Protocol (WAP). The server node 14 may be any one of a variety of commercially available processors able to support the incoming traffic as will be described in this particular embodiment in accordance with the particulars of the network connection 18d, the network 12 and the client systems 16a-16c.

In one embodiment, the server system may be, for example, a Unix-based server system, such as those commercially available by Sun, Hewlett Packard, IBM, and the like, with an ODBC compliant database software application running other web services and communication software. Each of the client systems may be, for example, and Intel or Motorola-based personal computer with industry standard networking capabilities, such as TCP/IP, PPP, WAP, and the like, with an internet browser, such as Microsoft Internet Explorer. The client system may also include an ODBC compliant database software for disconnected or standalone use of the MCS application.

The particular hardware and software included in each of the client and server nodes of an embodiment of the computer system 10 may vary with each particular application as well as the number and type of users accessing the system.

As described in more detail in following paragraphs, it should be noted that the server system 14 may include one or more other computer systems in which each of these computer systems may include one or more single or multiple processor computers.

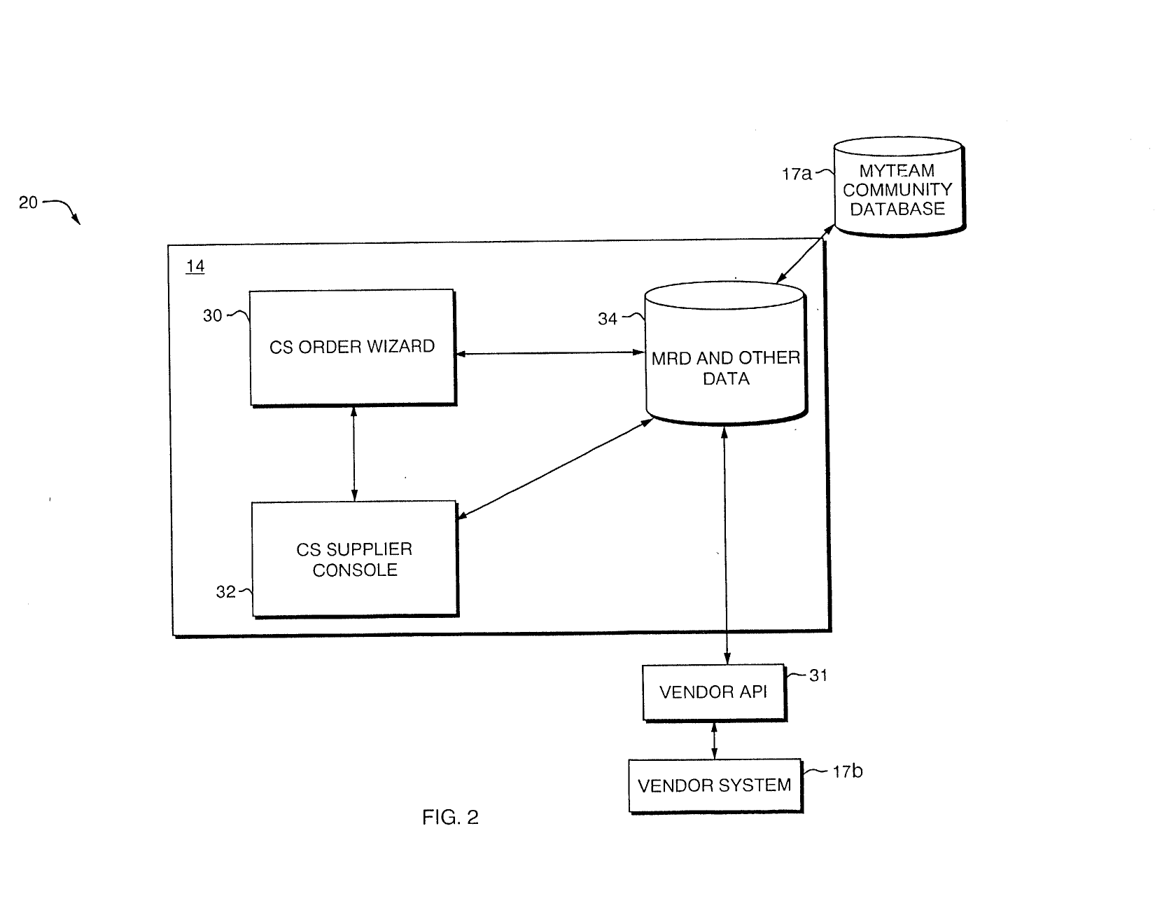

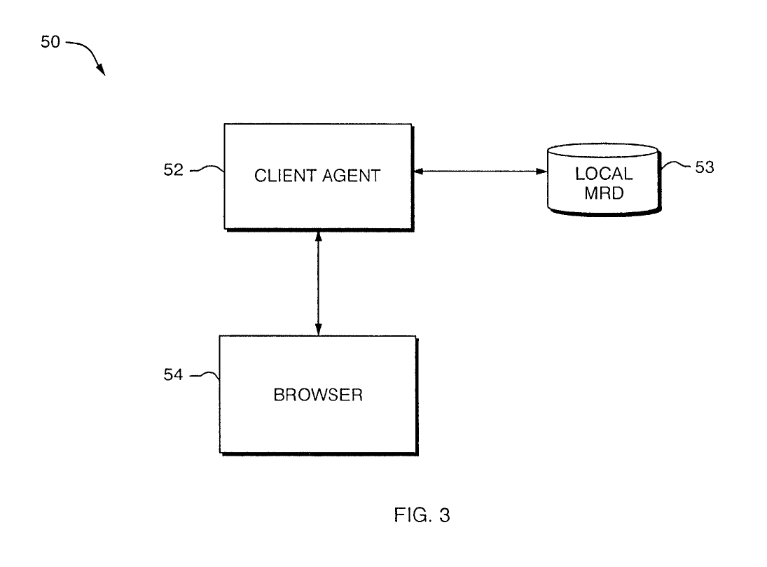

Myteam Concession Stand (MCS) is an application that may execute in the computer system of FIG. 1. More detail about the MCS is described elsewhere herein. The MCS may be structured as any one or more of a variety of different software applications, for example, such as a client-server application, a single stand-alone application executing on a single system, and the like. Described in connection with FIGS. 2 and 3 are modules that may be included, respectively, in each of a server and a client system.

The MCS application may be integrated with a membership database, such as the myteam Community Database as described in U.S. patent application Ser. No. 09/546,000, entitled “Structure for Accessing and Populating Community Websites”, filed Apr. 10, 2000, and U.S. patent application Ser. No. 09/545,739, filed on Apr. 10, 2000, entitled “Methods for Accessing and Populating Community Websites”, filed on Apr. 10, 2000. The myteam Community Database provides a unique, “online” community for amateur sports leagues, teams, players and their families. An embodiment of MCS may include tools combined with targeted content, e-commerce infrastructure and comprehensive security that provides a personalized experience to all of its members. This may be used in creating a new, highly efficient and targeted channel to provide goods and services from Suppliers (as described elsewhere herein) to both the leagues and teams (business to business) as well as a means to reach the players and their families (business to consumer). MCS is based on exclusive relationships with several major national youth sports organizations, such as Little League Baseball, Amateur Athletic Union, and Amateur Softball Association, which allow special access this market segment.

The myteam community database 17a may be a separate database server system or as part of the server system 14 in accordance with the system load and transactions of each embodiment and activity level therein. The myteam community database is a collection of information of members of the myteam community as described elsewhere in more detail. The myteam community may include one or more members and associated information that may be used by MCS in connection with performing data operations and activities.

The server system 14 and the myteam community database 17a may perform data transfers, for example, using ODBC connections or other connections in accordance with the particular database implementation and server system. The vendor system 17b is one used by a vendor to connect and use the MCS application on the server system 14.

Both the myteam community database server 17a and the vendor system 17b may be any one or more of a commercially available processors and other hardware and software components as appropriate in accordance with the particulars of each embodiment. For example, the myteam community database 17a may be an ODBC-compliant database application, such as using commercially available software by Oracle, running on a Unix-based operating system and any one or more Intel-based processors.

One embodiment of MCS is a web-based application that utilizing the unique membership and relationship information of the myteam.com community to provide direct, targeted marketing and order fulfillment services between leagues, teams and participants and the suppliers of goods and services. This application may utilize community based internet methods, structures and tools as described in U.S. patent application Ser. No. 09/563,723, filed May 2, 2000, entitled “Tools for Administering Leagues Under a Community Website Structure” to implement and provide functionality associated with direct marketing and supplier work flow model. MCS may provide functionality related to the food service needs of leagues and teams (such as, for example, snack bars and concession stands) as they relate to field events and providing a personalized, direct link to suppliers of those food services. Fodd services may include, for example, beverages, foods, dry goods, candies and the like. However, the MCS architecture and application is not limited to food services and may also include other products and services such as tee-shirts or other clothing, sports supplies, field maintenance, and the like.

Referring back to FIG. 1, a user on a client, such as one of 16a-16c, may connect to MCS executing on the server 14 using connection 12. If a user wishes to purchase or order an item, for example, the server may facilitate this process by further connecting to a vendor, supplier or the like. The vendor may also have a computer system, such as 17b, to which the member may be connected in the event that the member wishes to purchase products or services of that particular vendor.

Referring now to FIG. 2, shown is an example of software modules that may be included in an embodiment of the server 14 of FIG. 1. It should also be noted that other elements from FIG. 1 interfacing with the server system 14 are also shown. The Server software 20 may include three modules used in the MCS application described herein: the CS Order Wizard 30, the CS Supplier Console 32, and the myteam Resource Database (MRD) and infrastructure 34. Note that the vendor system 17b communicates with the MRD using the vendor specific application programming interface (API) that varies in accordance with particular vendor system. It should be noted that other embodiments may include other modules besides those included in this representation. Each of these components will now be described in more detail.

The CS Order Wizard provides users who are members a targeted list of goods and services specifically available to them. Based on their league and team affiliations and personal preferences (only available through the myteam community), the CS Order Wizard presents a categorized list of goods and services available to the member and their leagues and teams. This may include, for example, descriptions of the goods and/or services, current pricing, promotional offers, shipping and inventory availability, local and national vendor information, and other necessary information. The CS Order Wizard allows members to access local vendors, national or regional ones, and compare the goods and services. To ensure that MCS Users get the best prices possible, the MCS may allow its members to participate in “group buys” of goods and services across the entire myteam community. Additionally, the CS Order Wizard may provide order request and processing capabilities, which are integrated into the myteam e-commerce infrastructure. This may allow, for example, credit card processing, credit applications with vendors (for direct billing), return processing, and order status checking. Orders created by a user place a direct demand order on the supplier, utilizing the MCS programmable API (XML, standards based API) which then interfaces directly to the suppliers order processing and fulfillment systems. Additionally, this unique integration allows purchases by the league, team, and individual to be accumulated and applied to promotional program, such as, for example, the myteam Stadium Club and other group buying programs for myteam members, leagues, and teams. The security model included herein may be used to ensure only those users with the proper authority are granted the rights to process orders for leagues and team and the e-commerce industry standard infra-structure may provide additional security. Finally, the CS Order Wizard may allow for direct communications, via email, chat, bulletin boards, and other Internet technologies with these suppliers in order to enhance customer/supplier relationships. These MCS communication capabilities may be rules-based and may automatically send communications to both users and suppliers.

An embodiment of the CS Order Wizard may include a browser based interface to the myteam Resource database using, for example, java applets, cgi scripts, and dynamic HTML. An embodiment may also the CS Order Wizard as a part of a client-based application tied with a workflow-enabled synchronization module to minimize user interface response time, allow for offline or disconnected use and enhance the user experience. The client may utilize, for example, a commercially available personal computer, or other device, such as a handheld device, and communicate using any one or more communications protocol, such as, for example, TCP/IP, PPP, WAP, and the like.

An embodiment of the CS Supplier Console may provides suppliers with immediate orders from myteam members which are based on a pre-defined product offering, set pricing, and other standard terms and conditions. This application provides the supplier with a direct interaction with myteam members based on their current customer preferences and past buying behaviors. The CS Console may provide for direct communication with the myteam member on order questions, information or other requirements and clarifications. Additionally, the console may be used to review previous activity and provide direct pro-active solicitation (based on myteam member preferences) via a number of communication vehicles including myteam Messagecast, myteam notifications, email, and other permission based direct marketing provided to the myteam community. The CS Supplier Console may include a programmable application programming interface or API, such as using an XML, standards based API, which can directly interface into their internal order processing and fulfillment systems, dramatically reducing sale order processing time and effort. Additionally, substitute products can be instantly communicate to ready buyers through MCS, which can reduce lost sales and improve customer satisfaction. The suppliers may also generate reports, distribute specific survey or questionnaires regarding new product requirements, and assess future demand. An embodiment may use input that is very specific and targeted due to the proprietary information maintained in the myteam Resource Database (MRD) or related myteam community database.

The CS Supplier Console may be a browser based interface for the Suppliers, implemented using technology similar to that of the CS Order Wizard described elsewhere herein. An embodiment may also include the CS Supplier Console as part of a client-based application tied with a workflow-enabled synchronization module to minimize user interface response time, allow for offline or disconnected use and enhance the user experience. The client may utilize, for example, a commercially available personal computer, or other device, such as a handheld device, and communicate using any one or more communications protocol, such as, for example, TCP/IP, PPP, WAP, and the like.

The myteam Resource Database (MRD) is a data repository integrated into the myteam community databases. This database is structured to match the goods and services negotiated by myteam on behalf of their member to the specific, individual and personalized needs of leagues, teams, and members. The architecture of this data repository integrates all of the myteam community relationships and activities (between, National Organizations, Leagues, Teams, Coaches, Players, Volunteers, and families) into the Buyer/Supplier process. At each level (Organization, League, Team, or individual Member) the access to the myteam community database allows the MRD to provide unique, permission based direct marketing. This unique information creates a special type of relationship between the parties which maximizes the value of all transactions, provides personalized information for quick decision making, creates a safe and secure online marketplace for the myteam community, and greatly enhances the efficiency of the purchasing process for both parties. The MRD may also allow for group buying, auctions, and integration with the myteam Stadium Club and other loyalty programs of the myteam community site.

Following are features and functionality that may be included in an embodiment of the MCS. In particular, the any one or more of following may be included in an embodiment of the CS Order Wizard:

Member log-in and profile (linked to myteam community and custom settings)

Categorized list of goods and services

Search goods and/or services by geography, vendor, and price range

Access to past purchase history

Online order request forms with context sensitive help on both products and the operation of the CS Order Wizard

Instant messaging, chat, and other direct communications tools

Access to group buying account information, Stadium Club, and all other myteam features and tools

Support for all credit card processing based on secure, Internet standard system used in the myteam e-commerce infrastructure.

Allows for online Vendor Credit applications and direct billing to members

Links to vendor information and sites

Support for targeted advertising and special offers from suppliers

Inventory management and Order processing

Usage Reports

Staff scheduling and communication

Staff instructions

Any one or more of the following features and functionality may be included in an embodiment of the CS Supplier Console:

Myteam Supplier Login and Profile

Categorized listing of orders based on product, order date, order size, geography or other Supplier profile settings

Batch or real time order import through programmable (XML based) API

Batch or real time order status interface for viewing and/or updating order status information from suppliers system through the API

Access to customer history, subject to authentication and authorization

Instant messaging, chat, and other direct communications tools

Myteam website for members to access for vendor & product information

Direct marketing feature for targeted promotions and advertisements

Credit application for myteam members

Context sensitive help

Any or more of the following features and functionality may be included in an embodiment of the MRD:

Relational, object oriented database structure utilizing industry standard database application

Integrated into the myteam community database and architecture

Provides Vendor master files, Product master files, myteam Concession Stands master (currently registered CS Order Wizards), Order Header files, Order Detail files, and other necessary transactional and processing files which may be needed

Additionally, the server may include software providing any one or more features and functionality making it an electronic concession stand website:

MCS Web User Interface

Vendor ad areas, both local and myteam based

CS Schedule, as may be related to scheduled games at the team or league level

News, bulletins and announcements

Access to myteam or local fundraising products (tee shirts, bags, etc)

Access to myteam online registration for leagues and teams

Links to vendor areas

Links to league teams and tournaments

An MCS vendor may include software at a website having any one or more of the following features and functionality:

Product listing and specifications

Access to other Vendor Websites

Access to Vendor Technical Support

Vendor News, announcements and promotional programs

Contact information

Referring now to FIG. 3, shown is an example of software 50 that may reside in a client system, such as one included in the computer system of FIG. 1. The client software 50 may include a client agent 52, a browser 54, and a local copy of the MRD application software as previously described in connection with FIG. 2. The client agent 52 may include software used in interacting with the server system. An embodiment may initially store this and copy it to the client system, such as using the connection 12. The browser 54 may be software providing access to the Internet, for example, between a client and the server 14.

The local copy of the MRD software 51 may be used, for example, without the server such as when the server is “off-line” experiencing hardware and/or software problems. Using this local copy 51, a portion or all the functionality performed by the server system 14 may be performed by the client system using the local copy. It should be noted that an embodiment may provide only a portion of the functionality of the server system in the local MRD copy in accordance with each embodiment. For example, only a portion of the operations performed by the server system 14 may be available when off-line due to various size limitations and restrictions on a client system.

An embodiment of MCS may use a business process model based on the combination and tight integration of four separate business concepts: a) permission-based, local activation targeted marketing (direct marketing), b) consumer-based group buying, c) internet-based communication and messaging, d) workflow based order processing and fulfillment.

MCS has full integration into the myteam data structures where its members maintain information on their demographics, interests and activities, and teams and leagues may track their needs for equipment, food, and other supplies. Additionally, team and league information and profiles are maintained and updated regularly providing current information and means for reaching this very attractive demographic. MCS may leverage this information to provide two-way communication vehicles (see internet-based communication and messaging below) between suppliers and the consumers at the league, team or individual level. Targeted and need-based or permission-based marketing capabilities are highly favorable compared to traditional direct marketing methods due to higher sales conversions at much lower expense. This capability is necessary in the internet space, but MCS can provide targeted, local activation both on an online and offline basis: something very unique to the myteam community and MCS.

MCS brings group buying capabilities to its members, thus allowing the myteam community buying power to maximize values to each of its members. This also provides vendors with ways to increase their reach and grow volumes by gain more buyer through the use of this vehicle. As the internet brings buyers and sellers closer together, this may be a necessary capability for provide value to the business process. Additionally, other consumer based tools may be offered, such as auctions and swaps, to complement the group buying as well as facilitate secondary markets. This may be done within the secured environment of the myteam community. Vendors may be required to maintain high standards and quality business practices, as well as be subject to evaluation by myteam.com and its members. This may ensure the best products and services are provided.

An embodiment of MCS may utilize several forms of internet based communication to provide a highly interactive and personalized experience. For example, MCS may use standard email communication for specific communication between parties for customer inquiries and support, order acknowledgement, and marketing activities. Additionally, MCS may employ notification capabilities which are automatic, rules based notices that critical information is waiting for action, leading to a user-based event or response. This feature may be part of the work flow processing where buyers can be notified of shipments, new offers, or inventory issues and can quickly access this information. This capability may also be extended to other non-internet based communications via the use of the myteam Messagecast. This feature may allow a myteam MCS user (or myteam member), to send an e-mail, fax, beeper, or phone message to a group of people with just one action. This unique ability to leverage online and off-line communications vastly improves the sales process as well as the operations and use of products by myteam members.

In order to gain efficiencies for both the buyers and the sellers, MCS may integrate workflow based order processing and fulfillment capabilities. An embodiment may use event-based notifications and communications along with order interfaces through a standard API providing order entry and order status information by the users. An embodiment may allow rule-based activities and notification for inventory management, order processing, notification of group buying events, and other activities. This may further the efficiency and effectiveness of the sales process for all parties.

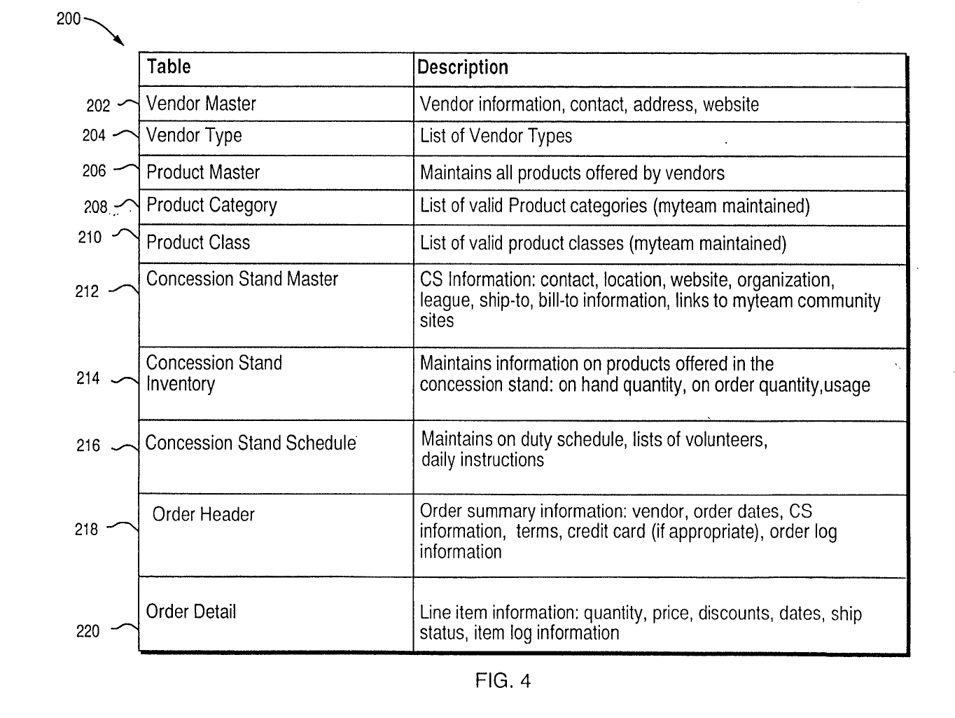

Referring now to FIG. 4, shown is an example of a list of tables 200 that may be included in an embodiment to represent data items included in the MRD and other data organization 34 of FIG. 2. Included in this list is a vendor master table 202 that includes vendor information, a vendor type table 204 that includes a list of vendor types, a product master table 206 that includes products offered by vendor, a product category table 208 that include a list of valid product categories, a product class table 210 that includes a list of value product classes, a concession stand master table 212 that includes concession stand information, a concession stand inventory table 214 that includes information regarding products offered for sale at the concession stand, a concession stand schedule table 216 that includes schedule information for the concession stand, an order header table 218 that includes order summary information, and an order detail table 220 that includes line item information used in connection with an order. It should be noted that one or more instances of the foregoing tables may be associated with a particular transaction, such as an order. These tables describe the data organization and structure of different entities that may be included in an embodiment.

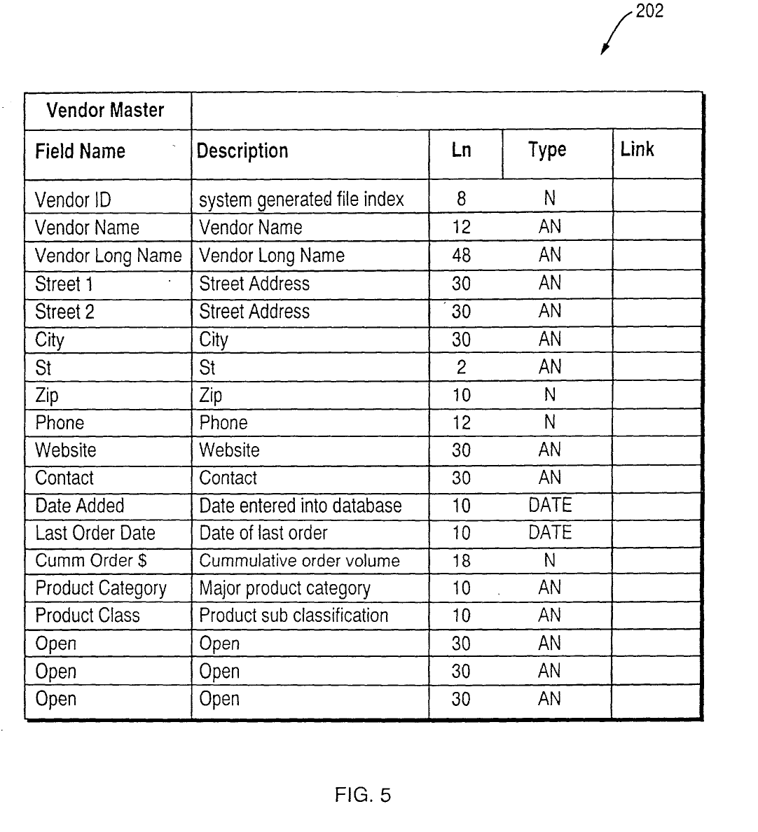

Referring now to FIG. 5, shown is a more detailed example of fields that may be included in an embodiment of the vendor master table 202.

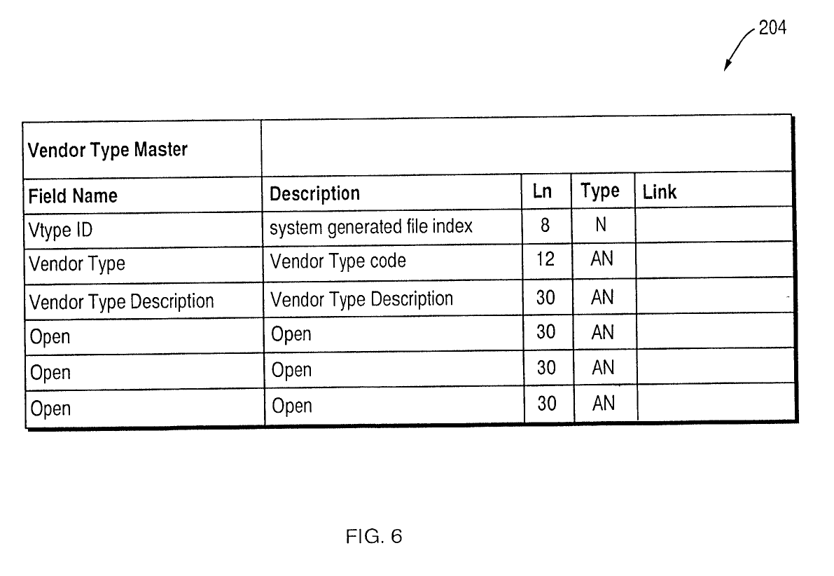

Referring now to FIG. 6, shown is a more detailed example of fields that may be included in an embodiment of the vendor type table 204.

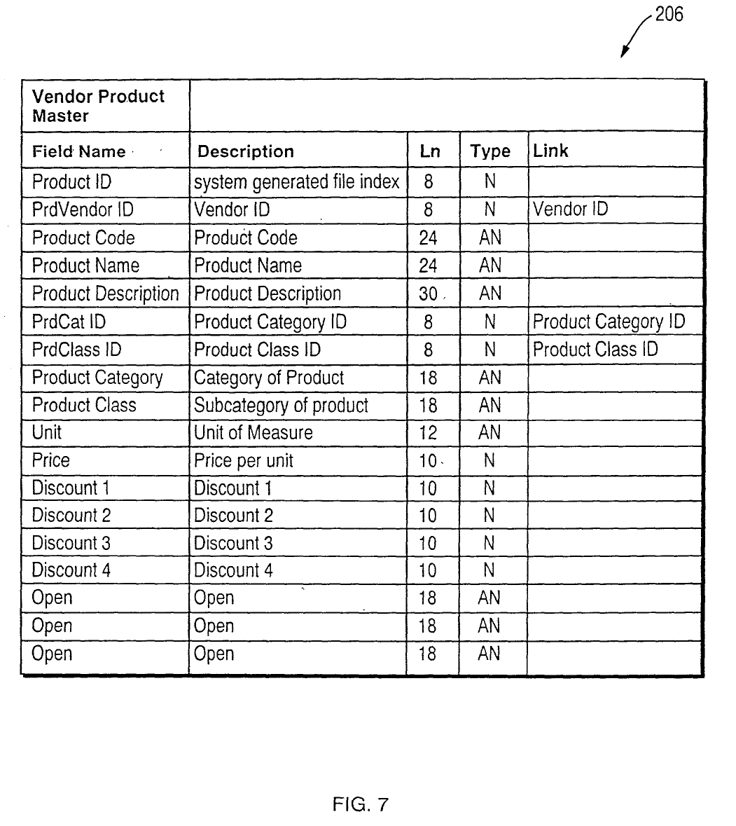

Referring now to FIG. 7, shown is a more detailed example of fields that may be included in an embodiment of the vendor product table 206.

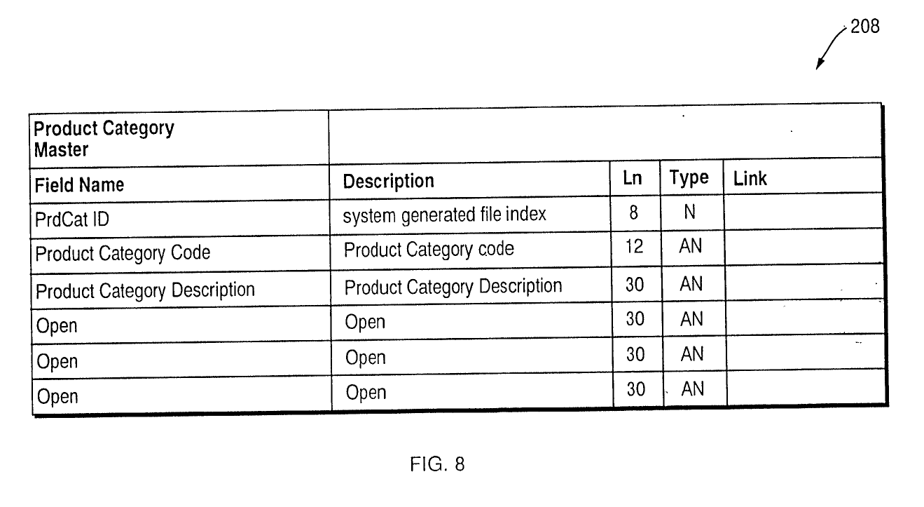

Referring now to FIG. 8, shown is a more detailed example of fields that may be included in an embodiment of the product category table 208.

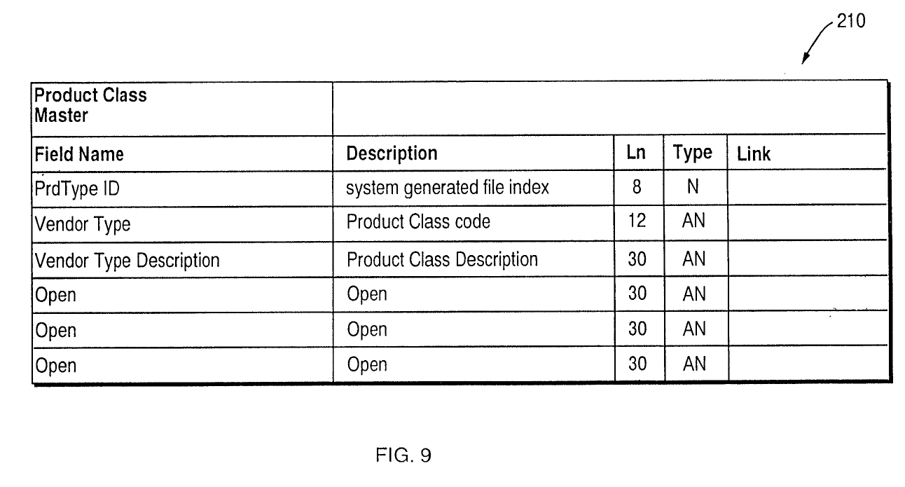

Referring now to FIG. 9, shown is a more detailed example of fields that may be included in an embodiment of the product class table 209.

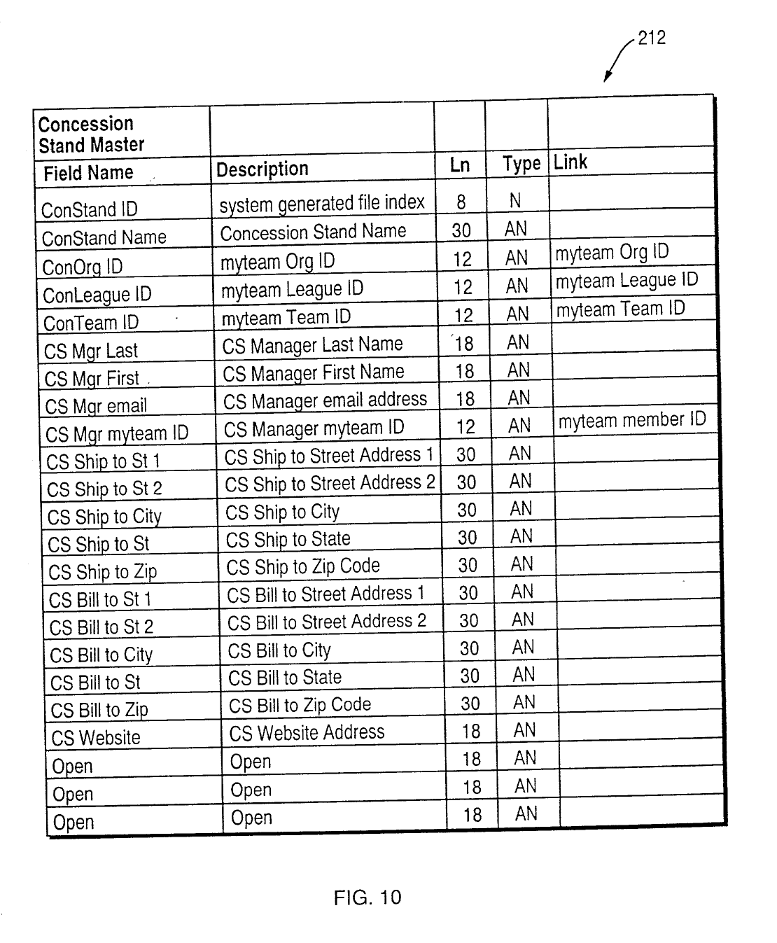

Referring now to FIG. 10, shown is a more detailed example of fields that may be included in an embodiment of the concession stand table 212.

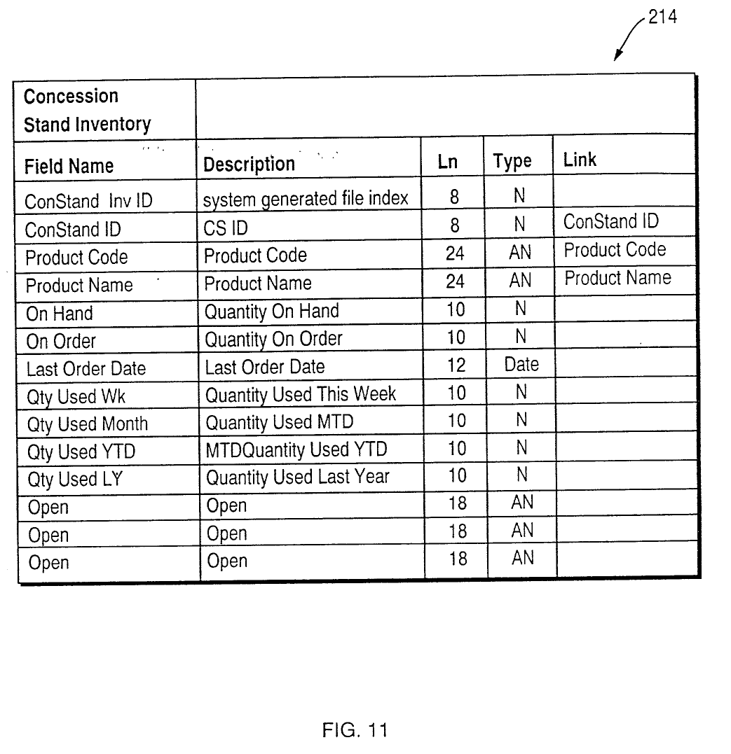

Referring now to FIG. 11, shown is a more detailed example of fields that may be included in an embodiment of the concession stand inventory table 214.

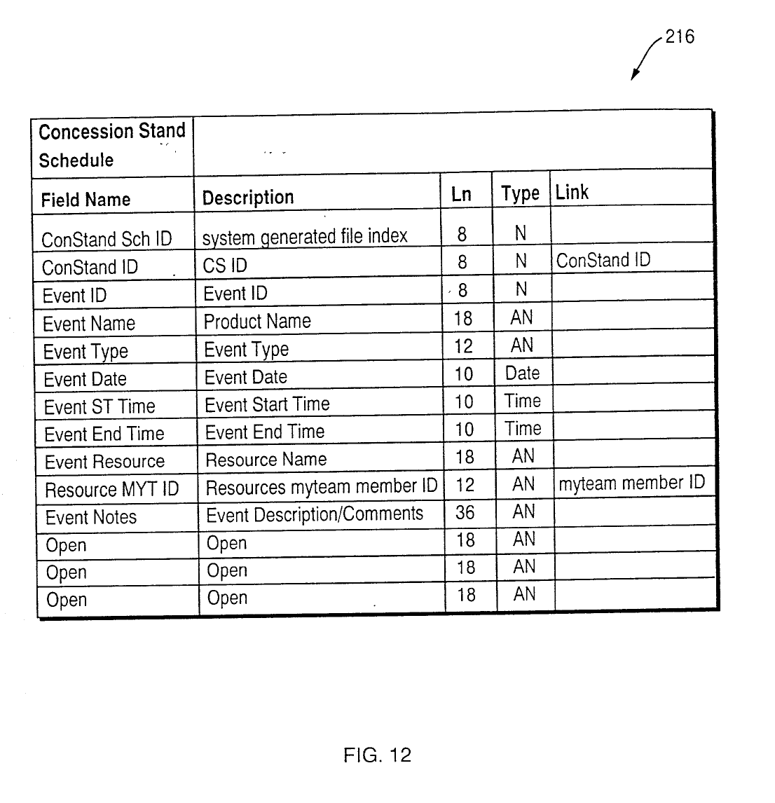

Referring now to FIG. 12, shown is a more detailed example of fields that may be included in an embodiment of the concession stand schedule table 216.

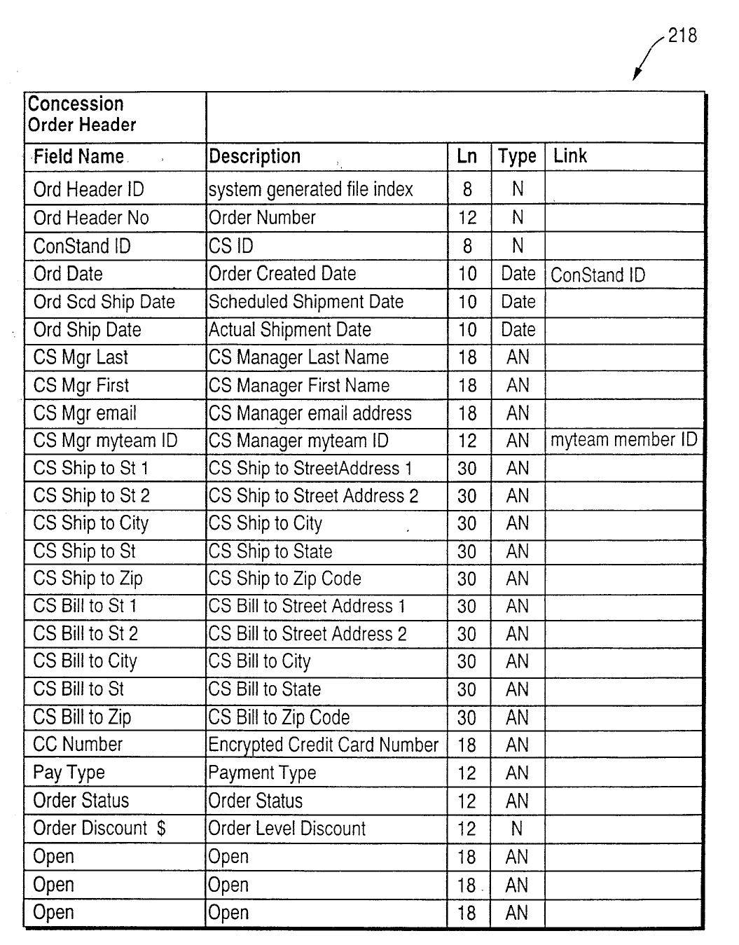

Referring now to FIG. 13, shown is a more detailed example of fields that may be included in an embodiment of the concession stand order header table 218.

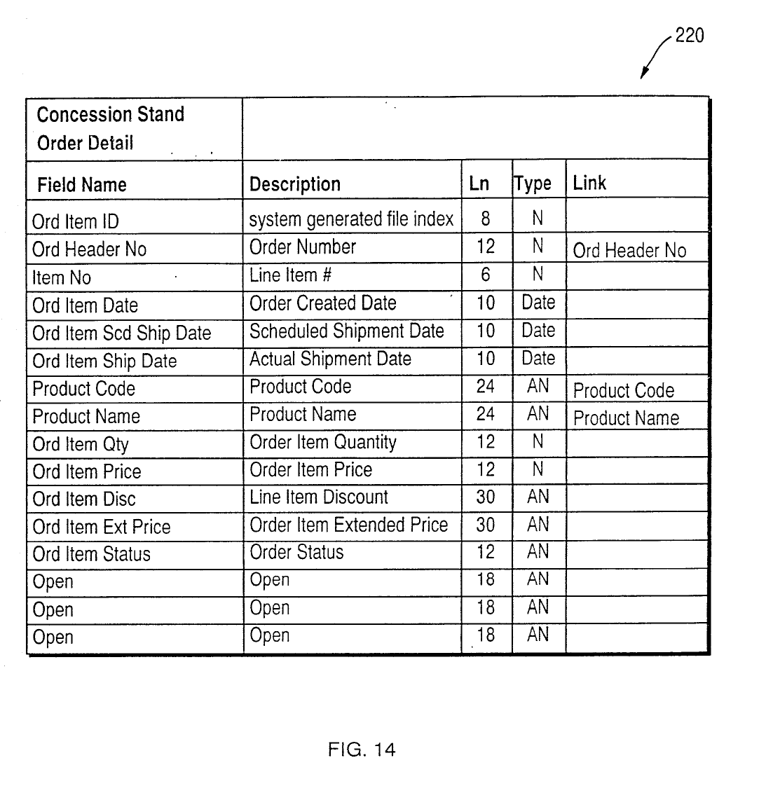

Referring now to FIG. 14, shown is a more detailed example of fields that may be included in an embodiment of the concession stand order detail table 220.

What will now be described is an example of how the MCS application may be used in the computer system of FIG. 1 by a user. It should be noted that a user and/or member of MCS may send messages to suppliers on other computer systems (not shown) that are able to communication with the server 14 using the Internet, or other communication medium. Communications, for example, such as messaging to suppliers described herein, may be sent to any one or more of a variety of devices including another computer system, a Wireless Access Procol (WAP) device, or other type of micro-browser device.

In one example, a week before a big tournament in town, the local Little League President is informed by a parent who is working the concession stand that they are almost out of everything. It seems someone forgot to take a look at the on hand inventory. The tournament is one of the biggest events for the league and generates a large portion of their funds.

The League President goes online invoking the MCS application. Since he has placed several orders before, he has set up standard orders to stock the field concession stand. He adds to the quantities to make sure he has enough for the tournament. He sends the 3 orders out to his suppliers. Next, he sends a quick instant message to each of the suppliers to please confirm that they will be able to deliver the soda, rolls, and candy needed. He then heads out to the field.

Each of the suppliers receive the order from the League President and downloads it into their order entry and processing system. They also get an instant message which was sent to them to confirm that they will be able to deliver. The first supplier notices that one of the products is out of stock, so he sends an instant message to the League President and recommends a substitute. This message pages the League President at the field. The other suppliers confirm the order through their CS Supplier Console and get started on fulfilling the order. Since myteam has special relationships with the vendors, the prices are pre-negotiated and the League will earn points towards their Stadium Club purchases.

The League President confirms the change to the order when he gets back from the field, noting that he may want to put a personal computer at the concession stand in the future. On Thursday, the League President and a couple of volunteers meet the delivery trucks and unload the supplies for the tournament.

It should be noted in the foregoing, the particular configurations of hardware and/or software should not be construed as a limitation of the techniques described herein. Rather, the particulars of the hardware and/or software may vary in accordance with each embodiment.

The foregoing techniques and arrangement described herein may be used in automatically sending, for example, customized messages, advertisements, notices of required actions, requests for information, and status of planned activities using any one or more of a variety of communication modes and mediums, including, for example, automated e-mail notification, automated phone calls with voice recordings, and the like. Consider the following example. Members of the myteam community may have member-specific data, or member profile information, in the myteam community database, such as member profile or preference information. This may also include specific member activities and member schedules, such as in connection with sporting events, practices, fundraisers, and the like. There may be different levels and roles associated with members, such as a member may be associated with one or more leagues, sports teams. A member may also be a concession stand manager, coach, administrator, and the like. A member may also be a player on a team. The relationship, if any, between members may be reflected in the myteam community database organization and structure, such as a hierarchical member structure and relationship between an organization, a league, a team and its members. Information about each member may stored and associated with each member. Member information may include demographic information such as where a member is located (city, state, and the like), associations with sports organizations and/or teams and/or other members, and contact information (e-mail address, mailing address, and the like).

A user of the MCS may be, for example, a member, supplier or vendor. If a user is a vendor, the vendor may use the information in the myteam community database to send customized messages to a particular group of members. A vendor may be interested in sending e-mail advertisements to team members located in a particular state for a particular product. The vendor may enter vendor profile information using MCS features indicating this. MCS may query the myteam community database for those members in accordance with the vendor profile information and member profile information that includes demographic information. A vendor may have a customized message to send to each member located in a particular city of that state. MCS may then automatically determine each member's e-mail address and send each member a customized message based on the particular city. This message may be an advertisement, such as an electronic coupon redeemable at a local store in the member's city selling the vendor's product. The foregoing may be performed using any one or more a variety of different techniques. In one embodiment, a member may define rules defining one or more predetermined conditions and one or more associated actions. Each of the one or more associated actions may take place upon the occurrence of the one or more predetermined conditions. The MCS system may determine the set of one or more members in accordance with the predetermined condition prior to the occurrence of the condition, or upon the occurrence of the condition. The server system may automatically obtain information about the one or more members from the myteam community database, such as the mode of communication with a member and related information. This may include, for example, an e-mail address or account information, a cell phone or other telephone number. The server system may then also automatically send a communication to each member using the member specified mode of communication. The communication may be customized using information related to one or more of, for example, member schedules, activities, and demographics.

Members may also use MCS, for example, in viewing data items and services for sale by vendors. Information may be displayed to a member in accordance with member profile information, such as if the member is only interested in beverages and snacks if a member is a concession stand manager. The information may provide the member with group discounts and may facilitate a purchase or order by a member.

In another example, a member may buy a particular item in a specific quantity. Based on past usage, as maintained in the myteam community database, a vendor may select an option to have a follow-up message sent electronically to the member at predetermined time period inquiring as to whether the member wishes to purchase additional quantities (inquiry message), or if the product was satisfactory, and the like. The creation of the initial order or purchase by a member may cause entries to be made in MCS which automatically send these messages to the member at a later date. Similarly, an automatic notification message may also be sent to the vendor indicating that an inquiry message has been sent to the member who made a prior purchase.

It should be noted that member information as may be included in the myteam community database may be private and inaccessible for view by a vendor or other party through MCS. In other words, the information in the myteam community database may be used by vendors through MCS but security measures may provide for limited access to those who use the myteam community database maintaining member privacy and data protection.

Using the foregoing, a team may be a member and individuals associated with the team, including a coach and each player, may also each be a member. The foregoing may be used to provide functionality such that a coach may be a particular type of player with an associated level of functionality and capabilities allowing him to assign another player as the individual responsible for purchasing certain items, such as sporting and beverage supplies for the team. This assigned individual may be the one which particular vendors direct inquiries, to advertisements, and the like. For example, this feature allows the coach to pre-assign team responsibilities to particular players and allow them to make a particular purchase. Further, additional information about when a team plays may be integrated with the particular beverages, for example, allowing a beverage company to communicate directly to the player or other individual and send the individual a targeted advertisement or coupon as an incentive to make a purchase of their product or beverage at a local retailer at predetermined points in time depending on when the team has scheduled games.

The foregoing provides a flexible way of doing business for both buyers and sellers of goods and services using automated techniques. It should be noted that although particular embodiments and configurations of hardware and/or software are described herein, the techniques described herein may be used in other embodiments with varying hardware and/or software configurations and architectures as known to those of ordinary skill in the art.

What has been described herein are some examples of how this unique and flexible arrangement and techniques described herein may be used.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method executed in a computer system for communicating with at least one member comprising:
determining member profile information associated with said at least one member, said member profile information including one of schedule information and member activity information;
determining vendor profile information associated with a vendor;
determining, by said vendor, a predetermined condition and associated action to be taken in response to an occurrence of said predetermined condition;
selecting said at least one member in accordance with at least one of: said predetermined condition and an occurrence of said predetermined condition;
automatically determining a preferred mode of communication of said at least one member; and
automatically sending a communication in accordance with said associated action to said at least one member using said preferred mode of communication, said communication being customized in accordance with one of said scheduling information and said member activity information.

2. The method of claim 1, wherein said member profile information includes demographic data.

3. The method of claim 2, wherein said member profile information is stored in a first database and said member profile information is obtained using a portion of vendor profile information and other information from a second different database.

4. The method of claim 3, further comprising:
organizing information about a plurality of members and organizations in said first database, said plurality of members and organizations being in a hierarchy of at least two levels wherein at least one of a member and organization at a second level is associated with one of a member and organization at a first level.

5. The method of claim 4, wherein a first member at said first level is one associated with at least one organization, and a second member at said second level is a associated with said first member and at least one organization.

6. The method of claim 5, wherein said communication is one of: a customized proposed action, customized information, and customized request, and the method further comprises:
automatically defining, structuring, and sending said communication to said second member, said communication including information about at least one of: demographic, schedules and other activities of said second member.

7. The method of claim 6, wherein said vendor is only permitted use access of said member profile information in accordance with a privacy policy associated with said member profile information.

8. A computer program product for communicating with at least one member comprising machine executable code for:
determining member profile information associated with said at least one member, said member profile information including one of schedule information and member activity information;
determining vendor profile information associated with a vendor;
determining, by said vendor, a predetermined condition and associated action to be taken in response to an occurrence of said predetermined condition;
selecting said at least one member in accordance with at least one of: said predetermined condition and an occurrence of said predetermined condition;
automatically determining a preferred mode of communication of said at least one member; and
automatically sending a communication in accordance with said associated action to said at least one member using said preferred mode of communication, said communication being customized in accordance with one of said scheduling information and said member activity information.

9. The computer program product of claim 8, wherein said member profile information includes demographic data.

10. The computer program product of claim 9, wherein said member profile information is stored in a first database and said member profile information is obtained using a portion of vendor profile information and other information from a second different database.

11. The computer program product of claim 10, further comprising machine executable code for:
organizing information about a plurality of members and organizations in said first database, said plurality of members and organizations being in a hierarchy of at least two levels wherein at least one of a member and organization at a second level is associated with one of a member and organization at a first level.

12. The computer program product of claim 11, wherein a first member at said first level is one associated with at least one organization, and a second member at said second level is a associated with said first member and at least one organization.

13. The computer program product of claim 12, wherein said communication is one of: a customized proposed action, customized information, and customized request, and the computer program product further comprises machine executable code for:
automatically defining, structuring, and sending said communication to said second member, said communication including information about at least one of: demographic, schedules and other activities of said second member.

14. The computer program product of claim 13, wherein said vendor is only permitted use access of said member profile information in accordance with a privacy policy associated with said member profile information.
